(19) United States
(12) Patent Application Publication
(10) Pub. No.: US 2026/0115734 A1
(43) Pub. Date: Apr. 30, 2026

(54) SAND SEPARATION SYSTEMS AND METHODS

(71) Applicant: Integrated Separation Technologies, LLC, Appleton, WI (US)

(72) Inventors: Corey E. Bock, Eau Claire, WI (US); David D. Juen, Roberts, WI (US)

(21) Appl. No.: 19/361,732

(22) Filed: Oct. 17, 2025

Related U.S. Application Data
(60) Provisional application No. 63/714,779, filed on Oct. 31, 2024.

(51) Int. Cl. B03B 5/34

(52) U.S. Cl. CPC B03B 5/34

(57) ABSTRACT

A sand separation system includes a first hydrocyclone and a second hydrocyclone. The first hydrocyclone includes a first adjustable apex via which underflow of the first hydrocyclone is conveyed. The second hydrocyclone includes a second adjustable apex via which underflow of the second hydrocyclone is conveyed. A first apex aperture diameter of the first adjustable apex is greater than a second apex aperture diameter of the second adjustable apex.

This application claims the benefit of priority of U.S. Provisional Application No. 63/714,779, filed Oct. 31, 2024, which is hereby incorporated by reference in its entirety.

### BACKGROUND

Sand separation systems (sometimes referred to as sand cleaning or grit cleaning systems) are employed in various applications to separate sand from other materials for reuse of the sand. For example, a sand manure separator unit is a manure management system used by dairy farms to separate manure and other organic material from sand to create clean bedding for cows. The bedding is placed in stalls and provides an ergonomic surface that reduces bacterial growth, minimizes disease transmission and benefits the overall health of the cows.

### SUMMARY

The present inventors have recognized, inter alia, multiple improvements to existing sand separation systems that advantageously separate and cleanse sand from a slurry of liquids and solids, e.g. liquid and solid organic materials.

The present inventors have recognized, inter alia, that employing two stages of hydrocyclone separation can improve bulk and fine sand separation of a substantial majority of the liquid and solid organic materials from sand before washing and further separating the sand in a sand washing tub/reservoir (also referred to as tub separator). For example, a sand separation system according to this disclosure includes two stages of hydrocyclone separation in parallel to improve bulk and fine sand separation of a substantial majority of the liquid and solid organic materials from the sand.

Additionally, the present inventors have recognized, inter alia, that the agitator in the slurry tank of an agricultural sand separation system can be improved with by employing a plurality of rotor assemblies, which advantageously function to set the slurry in the agitator in motion and to maintain an appropriate and advantageous distribution of constituent materials (e.g., biological and sand) of the slurry.

Additionally, the present inventors have recognized, inter alia, that employing water jets at various places in a sand washing tub/reservoir (also referred to as tub separator) of a sand separation system can improve final washing and separation of sand from fine solid materials adhered to the sand particles in the tub.

In an example, a sand separation system includes a first hydrocyclone and a second hydrocyclone. The first hydrocyclone includes a first adjustable vortex finder via which overflow of the first hydrocyclone is conveyed. The second hydrocyclone includes a second adjustable vortex finder via which overflow of the second hydrocyclone is conveyed. A first vortex aperture diameter of the first adjustable vortex finder is greater than a second vortex aperture diameter of the second adjustable vortex finder.

In an example, a sand separation system includes a first hydrocyclone and a second hydrocyclone. The first hydrocyclone has a first adjustable vortex finder and first adjustable apex via which underflow of the first hydrocyclone is conveyed to the tub separator. The second hydrocyclone has a second adjustable vortex finder and second adjustable apex via which underflow of the second hydrocyclone is conveyed to the tub separator in parallel with the underflow of the first hydrocyclone. A first apex aperture diameter of the first adjustable apex is greater than a second apex aperture diameter of the second adjustable apex.

In an example, a method of separating sand from other solids and liquids in a slurry includes conveying the slurry to a first hydrocyclone having a first adjustable vortex finder and first adjustable apex, conveying underflow of the first hydrocyclone from the first apex to a tub separator, separating a pre-separation fluid including sand and other solids and liquids in the tub separator, and conveying the pre-separation fluid to a second hydrocyclone having a second adjustable vortex finder and second adjustable apex via which underflow of the second hydrocyclone is conveyed to the tub separator in parallel with the underflow of the first hydrocyclone.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components, sub-components of a larger logical or physical system, or the like. The drawings illustrate generally, by way of example, but not by way of limitation, various examples described in the present disclosure.

FIG. 1 schematically depicts an example sand separation system in accordance with this disclosure.

FIG. 2 is a plan view schematically depicting an example raw slurry reservoir of a sand separation system in accordance with this disclosure.

FIG. 3 schematically depicts another example sand separation system in accordance with this disclosure.

FIG. 4 is a plan view schematically depicting another example raw slurry reservoir of a sand separation system in accordance with this disclosure.

FIG. 5 is a flow chart depicting a method of sand separation in accordance with this disclosure.

### DETAILED DESCRIPTION

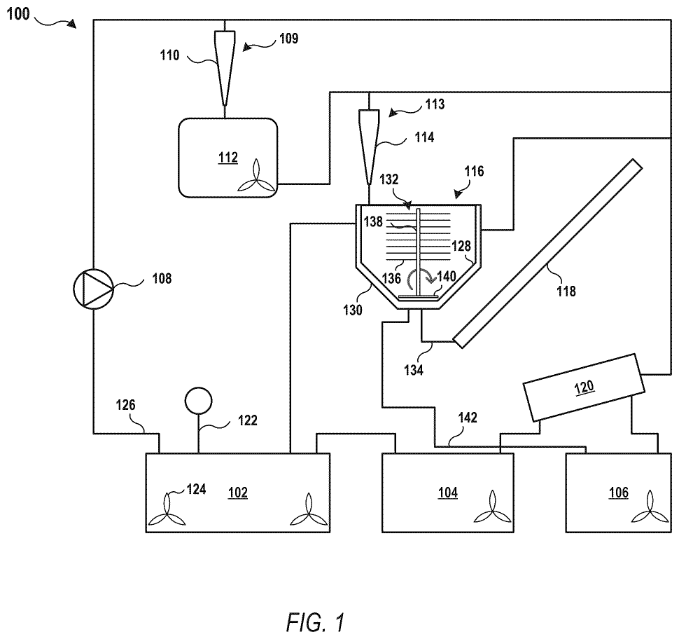

FIG. 1 schematically depicts example sand separation system 100 in accordance with this disclosure. Sand separation system 100 includes raw slurry reservoir 102, discharge reservoir 104, flush reservoir 106, pump(s) 108, first hydrocyclone 110, pre-separation reservoir 112, second hydrocyclone 114, tub separator 116, and auger(s) 118. Sand separation system 100 also includes sloped separator 120 and multiple fluid conduit circuits interconnecting the components and stages of the system. Conduit employed in the fluid circuits can include multiple materials. In examples, the conduit employed in fluid circuits of sand separation system 100 and other systems in accordance with this disclosure can be high-density polyethylene (HDPE).

In examples, sand separation system 100 includes raw slurry reservoir 102 into which an unprocessed slurry of liquids, solid organic materials, and sand is deposited, e.g. via inlet 122 for processing by the system. Raw slurry reservoir 102 can include an agitator 124 with one or more rotor assemblies/impellers/propellers (e.g., depending on the size of the reservoir) to mix the slurry introduced into the reservoir. In examples, agitator 124 can include two or more rotors/impellers/propellers, which advantageously function to set the slurry mix in motion (propel the mixture) within reservoir 102 and to maintain an appropriate mix of constituent materials of the slurry (e.g., fluid solution with liquid, organic materials and suspended inorganic grit such as sand).

In an example, agitator 124 of raw slurry reservoir 102 can include a plurality of rotor assemblies in reservoir 102 and configured to be submerged in the bulk fluid/slurry mixture. Each rotor assembly can include a motor operatively connected and configured to rotate an impeller or propeller. In examples, multiple rotor assemblies, a power of the motor, a rate of rotation of the impeller or propeller, and a size of the impeller or propeller of each of the plurality of rotor assemblies is selected to both propel and mix the slurry in reservoir 102 without separating sand from the slurry. For example, for a raw slurry reservoir in a range from 19,000 to 30,000 gallons, an example agitator can include 2 to 3 rotor assemblies. Each of the rotor assemblies can include an approximately 12 HP motor rotating an impeller or propeller with an outer diameter in a range from approximately 30 inches to approximately 31 inches at approximately 172 RPMs. In an example, for a raw slurry reservoir in a range from 30,000 to 60,000 gallons, an example agitator can include 6 to 8 rotor assemblies with four of the rotor assemblies including a 12 HP motor and 2-4 of the rotor assemblies including a 30 HP motor. The 12 HP motors can rotate an impeller or propeller with an outer diameter in a range from approximately 30 inches to approximately 31 inches at approximately 172 RPMs and the 30 HP motors can rotate an impeller or propeller in a range from approximately 30 inches to approximately 31 inches at approximately 320 RPMs.

The rotors/impellers/propellers of agitator 124 and other agitators in sand separation system 100 can be coated to improve the performance and longevity of the rotors. For example, coating rotors/impellers/propellers can inhibit abrasion from the sand laden slurry moving through example system 100 and other sand separation systems in accordance with this disclosure. In examples, rotors/impellers/propellers included in examples according to this disclosure can be coated in a rubber or other elastomeric material. In examples, rotors/impellers/propellers included in examples according to this disclosure can be coated in a polyurethane. For example, rotors/impellers/propellers of agitator 124 and other agitators in sand separation systems according to this disclosure can include a metallic core and a rubber or polyurethane layer covering at least a portion of a plurality of working surfaces of the rotor/impeller.

Additionally, to prevent initial clogging as raw slurry is introduced into raw slurry reservoir 102, the rotors/impellers/propellers of agitator 124 may be clocked circumferentially in the reservoir relative to slurry inlet 122 and outlet 126 of the reservoir and may be configured to generate flow of the slurry in a prescribed direction, e.g. clockwise or counterclockwise. In an example, a cylindrical raw slurry reservoir 102 includes agitator 124 including one or more rotors positioned in a range from approximately three to approximately six inches from the bottom of the reservoir. Raw slurry reservoir 102 can have a circular cross-sectional shape or other cross-sectional shapes, e.g., oblong, oval, as examples.

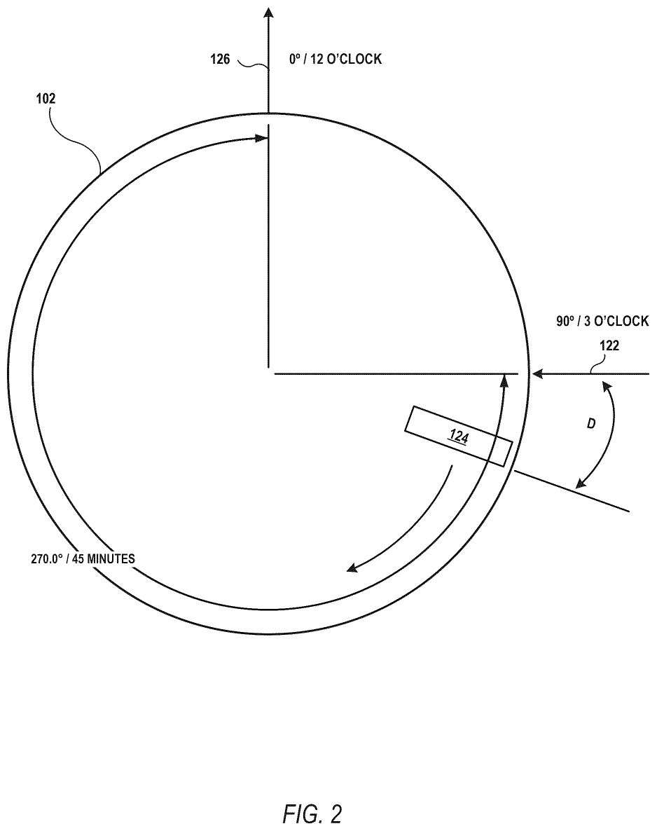

In an example, a portion of which is schematically depicted in FIG. 2, raw slurry is introduced into slurry reservoir 102 via inlet 122 at approximately 3 o'clock or 90 degrees from a 12 o'clock position and slurry outlet 126 out of which the mixed slurry in the reservoir is transferred for further processing in the system is at the 12 o'clock or 0-degree position. In this example, agitator 124 can be positioned circumferentially at greater than the 3 o'clock/90-degree position and configured to generate clockwise flow of the slurry. In examples, the agitator in a raw slurry tank is positioned circumferentially in the reservoir and configured to generate flow in either a clockwise or counterclockwise direction such that the agitator moves the slurry from a raw slurry inlet 270 degrees (45 minutes) or more before it reaches the raw slurry reservoir outlet. Additionally, in examples, agitator 124 may be positioned a predetermined minimum distance, D, downstream (in the direction of flow in slurry in reservoir 102) of inlet 122. In an example, agitator 124 may be positioned a distance, D, of less than or equal to 5 feet downstream (in the direction of flow in slurry in reservoir 102) of inlet 122.

Pump(s) 108 draw the mixed raw slurry from slurry reservoir 102 via outlet 126. In examples, pump(s) 108 can include one or more, e.g. two positive displacement pumps. The stroke of pump(s) can be set to evacuate all of the material, e.g. sand at the bottom of the stroke. In examples, sensors/switches are employed to control the stroke of pump(s) 108. For example, non-contact proximity switch(es) can be employed to control pump stroke. Pump(s) 108 draw the mixed raw slurry from slurry reservoir 102 and pump the slurry to the first of two hydrocyclones. Although sand separation system 100 is depicted with pump(s) 108 located downstream of outlet 126 of slurry reservoir 102, the example system and other systems in accordance with this disclosure can include additional pumps at additional locations to convey fluid through the system.

In examples, sand separation system 100 (and other example systems in accordance with this disclosure) can include two hydrocyclone stages in series with one or more hydrocyclones 110 and 114 in each stage. For example, each of first and second hydrocyclone stages 109 and 113 can include two hydrocyclones. In examples, each hydrocyclone can include an adjustable vortex finder and adjustable apex. Each of first hydrocyclone 110 and second hydrocyclone 114 is configured to separate solids from the slurry mix flowing through the system. Including two hydrocyclones in series in the system improves the sand separation from the slurry. In examples, the dual series hydrocyclones 110 and 114 improves solid organic material separation from sand, which reduces the load on tub separator 116 downstream of the hydrocyclones. Additionally, the adjustable vortex finder and apex improve the flexibility to modulate the hydrocyclone separation of materials for different system pressures, versus requiring a fixed system pressure for a prescribed and non-adjustable vortex finder.

The raw slurry is received and processed by hydrocyclone 110 and the partially processed fluid is collected in pre-separation reservoir 112. The partially processed fluid is then pumped from pre-separation reservoir 112 to the second hydrocyclone 114 for additional processing, after which the partially processed fluid collects in tub separator 116.

Tub separator 116 can include perforated basket 128 nested within and concentric with a liquid retaining outer tub 130 and agitator 132 aligned with a central axis of the basket and tub. Tub separator 116 can include a conical lower portion in which sand collects before exiting outlet 134 of the tub separator to be processed by one or more augers 118. The partially processed fluid is received in tub separator 116, e.g. in inner basket 128 and is processed by one or more mechanisms to further separate sand from liquid and other solids, e.g., organic solids, which separated fluid mixture is expelled through apertures in basket 128 and/or weired off and out of system as it collects toward the top of the tub and flows over inner basket 128 into outer tub 130.

Tub separator includes agitator 132, which can be configured to spin about the central axis and can include a plurality of radially extending fingers 136 distributed along a length of a central agitator shaft 138. Agitator 132 can also include base plate 140, which, as the agitator spins, covers and uncovers one or more apertures in the bottom of the tub separator to allow sand to exit via outlet 134 for further (in some examples, final) processing by auger(s) 118. Agitator 132 can spin to cause fingers 136 to move through the slurry in tub separator 116. Gravity and centrifugal forces in tub separator 116 with the rotating agitator 132 will cause the liquid and less dense/lighter solids to be expelled radially outward through the perforated basket into liquid the retaining tub while the sand is taken out of suspension in, e.g., the organic solids (or other solids in the mixture) and collects in the bottom of the separator tub.

Tub separator 116 may also employ a sand filtration backwashing system to further separate the sand from, e.g., solid organics in the tub separator. In examples, a flush liquid, e.g. water is introduced toward the bottom of the tub separator and thereby caused to flow through the sand collected therein. The location at which the flush liquid is introduced can vary. In examples, the flush water is introduced from below sand collected in the bottom of tub separator 116. In examples, flush water is introduced from the side/periphery of tub separator at different heights of the sand collected in the bottom of the tub. In examples, one or more conduits are arranged across an interior dimension, e.g., across the diameter of tub separator 116 to better distribute the flush liquid throughout the sand collected at the bottom of the tub. The flush liquid can come from, e.g. flush reservoir 106 via flush supply line 142, as depicted in the example of FIG. 1. In examples, the flush liquid employed to backwash sand in tub separator 116 can be fresh water (potable or non-potable) pumped into sand separation system 100 from a local or remote water source. The flush liquid backwashes the accumulated sand in the bottom of tub separator 116 by separating out lighter/less dense solids and pushing them upward. The action of agitator 132 of tub separator 116 and the sand filtration backwashing system can improve separation and cleansing of the sand in the system.

In addition to backwashing a flush liquid into tub separator 116, air can be employed to assist in separating unwanted materials form the sand and to reduce water (or other liquid) consumption. In examples, air can be introduced into tub separator 116 at one or more locations, which can act to break organic solids from sand and air bubbles in the fluid mixture may also act to carry organic solids upward in the fluid in the tub to be weired off and out of the system.

Processed sand collects in the bottom of tub separator 116 and base plate 140, covers and uncovers one or more apertures in the bottom of the tub separator to allow sand to exit via outlet 134 for further (in some examples, final) processing by auger(s) 118. In examples, a plurality of augers 118, e.g. two augers 118 are employed in sand separation system 100. In examples, auger(s) 118 can be shaftless auger(s), which can function to assist with sand separation by allowing liquid to leave the sand as it travels upward in an enclosed tube in which each auger is arranged. The auger tubes can be made from a variety of materials. In an example, the auger tubes are made from a stainless steel and with an HDPE lining, or another material with similar characteristics as HDPE. In examples, auger(s) 118 can operate continuously.

Additionally, in examples, auger(s) 118 can run periodically. For example, one or more of auger(s) 118 can be controlled to run for a period of time and can be shut down for a period of time. Different ones of auger(s) 118 can be run on different schedules/frequencies of operation and multiple of auger(s) 118 can be run on the same schedule/at the same frequency.

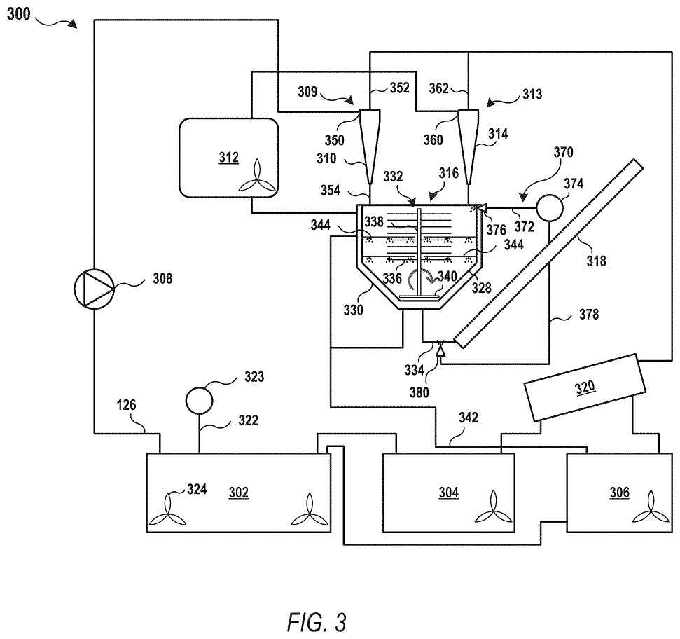

FIG. 3 schematically depicts another example sand separation system 300 in accordance with this disclosure. Sand separation system 100 includes raw slurry reservoir 302, discharge reservoir 304, flush reservoir 306, pump(s) 308, first hydrocyclone stage 309 including first hydrocyclone 310, pre-separation reservoir 312, second hydrocyclone stage 313 including second hydrocyclone 314, tub separator 316, and auger(s) 318. Sand separation system 300 also includes sloped separator 320 and multiple fluid conduit circuits interconnecting the components and stages of the system. Conduit employed in the fluid circuits can include multiple materials. In examples, the conduit employed in fluid circuits of sand separation system 300 and other systems in accordance with this disclosure can be high-density polyethylene (HDPE).

In examples, example sand separation system 300 (and other example sand separation systems according to this disclosure, including, e.g., system 100) can be a sand manure separator system used by a dairy farm to separate manure and other organic material from sand to create clean bedding for cows. Sand separation system 300 can receive and process a slurry of liquids, solid organic materials, and sand from the dairy farm, process the slurry in multiple separation stages to separate and wash the sand from/of other materials, and output a supply of clean sand relatively free of other undesirable materials, e.g. liquid and solid organic materials. The separated and washed sand can then be transported to cattle stalls and used as bedding that provides an ergonomic surface that reduces bacterial growth, minimizes disease transmission and benefits the overall health of the cows.

Sand separation system 300 includes raw slurry reservoir 302 into which an unprocessed slurry of liquids, solid organic materials, and sand is deposited, e.g. via inlet 322 for processing by the system. The raw slurry including sand to be separated and washed by system 300 can be delivered to inlet 322 from a variety of sources and in a variety of ways. In general, however, the raw slurry comes from slurry source 323 to inlet 322 of raw slurry reservoir 302.

Raw slurry reservoir 302 can include an agitator 324 with one or more rotor assemblies/impellers/propellers (e.g., depending on the size of the reservoir) to mix the slurry introduced into the reservoir. Before pumping the raw slurry from raw slurry reservoir 302 into sand separation system 300 for separation and washing of sand, it is important the constituent materials of the raw slurry, e.g. liquid and solid organic materials and sand are properly distributed in the slurry. In other words, it is important that the slurry has a relatively even distribution of constituent materials, e.g. versus uneven portions of high solid organics and sand concentration and portions of mostly liquid constituents. As described in more detail below, the configuration of raw slurry reservoir 302 and agitator 324 can function to properly and advantageously mix the raw slurry in the reservoir for introduction into and processing by sand separation system 300.

In examples, agitator 324 can include two or more rotors/impellers/propellers, which advantageously function to set the slurry mix in motion (propel the mixture) within reservoir 302 and also to maintain an appropriate mix of constituent materials of the slurry (e.g., fluid solution with liquid, organic materials and suspended inorganic grit such as sand).

In an example, agitator 324 of raw slurry reservoir 302 can include a plurality of rotor assemblies in reservoir 302, which are configured to be submerged in the bulk fluid mixture/slurry. Each rotor assembly can include a motor operatively connected and configured to rotate an impeller or propeller. In examples, multiple rotor assemblies, a power of the motor, a rate of rotation of the impeller or propeller, and a size of the impeller or propeller of each of the plurality of rotor assemblies is selected to both propel and mix the slurry in reservoir 302 without separating sand from the slurry. A challenge with mixing the slurry in raw slurry reservoir 302 can be maintaining a relatively even distribution of constituent materials of the slurry while also not taking the sand out of suspension with other materials at this stage of the system. If agitators 324 propel and mix the slurry too much, the sand may come out of suspension and sink to the bottom of raw slurry reservoir 302 and thereby not be pumped into sand separation system 300 for processing.

In examples, agitator 324 can include a plurality of rotor assemblies. The power of the motor, a rate of rotation of the impeller/propeller, and a size of the impeller/propeller of each of the plurality of rotor assemblies is selected to both propel and mix the raw slurry in raw slurry reservoir 302 without separating the sand from the slurry. In examples, different ones of the plurality of rotor assemblies can have different motor powers, different rates of impeller/propeller rotation, and/or different impeller/propeller sizes. In examples, the motor power, impeller/propeller rotation rate, and/or impeller/propeller size of the plurality of rotor assemblies can be the same.

In examples, agitator 324 in raw slurry reservoir 302 can include 1 to 8 rotor assemblies. Each of the rotor assemblies can include motor(s) operatively connected to and powering an impeller/propeller of the rotor assembly and the motor(s) can have a power rating in a range from 4 to 30 HP. The impeller(s)/propeller(s) can have outer diameter in a range from approximately 24 inches to approximately 43 inches.

In examples, for a raw slurry reservoir 302 in a range from 19,000 to 30,000 gallons, an example agitator 324 can include 2 to 3 rotor assemblies. Each of the rotor assemblies can include an approximately 12 HP motor rotating an impeller/propeller with an outer diameter in a range from approximately 30 inches to approximately 31 inches at approximately 172 RPMs. In an example, for a raw slurry reservoir in a range from 30,000 to 60,000 gallons, an example agitator can include 6 to 8 rotor assemblies with four of the rotor assemblies including a 12 HP motor and 2-4 of the rotor assemblies including a 30 HP motor. The 12 HP motors can rotate an impeller/propeller with an outer diameter in a range from approximately 30 inches to approximately 31 inches at approximately 172 RPMs and the 30 HP motors can rotate an impeller/propeller in a range from approximately 30 inches to approximately 31 inches at approximately 320 RPMs.

As another example, for a raw slurry reservoir 302 of approximately 30,000 gallons, an example agitator 324 can include 3 rotor assemblies. The impeller(s)/propeller(s) of the rotor assemblies of agitator 324 can have an outer diameter in a range from approximately 32 to approximately 43 inches. In examples, the impeller(s)/propeller(s) of the rotor assemblies of agitator 324 can have an outer diameter of approximately 38 inches.

The motors of the rotor assemblies of agitator 324 can be configured to rotate the impeller(s)/propeller(s) at a speed in a range from approximately 120 to approximately 200 RPMs. In examples, the motors of the rotor assemblies of agitator 324 can be configured to rotate the impeller(s)/propeller(s) at a speed in a range from approximately 150 to approximately 175 RPMs. In examples, the motors of the rotor assemblies of agitator 324 can be configured to rotate the impeller(s)/propeller(s) at a speed of approximately 160 RPMs.

The motors of the rotor assemblies of agitator 324 can include a power in a range from approximately 4 to approximately 30 HP. In examples, the motors of the rotor assemblies of agitator 324 can include a power in a range from approximately 4 to approximately 15 HP. In examples, the motors of the rotor assemblies of agitator 324 can include a power of approximately 12.2 HP.

The rotors/impellers/propellers of agitator 324 and other agitators in sand separation system 300 can be coated to improve the performance and longevity of the rotors. For example, coating rotors/impellers/propellers can inhibit abrasion from the sand laden slurry moving through example system 300 and other sand separation systems in accordance with this disclosure. In examples, rotors/impellers/propellers included in examples according to this disclosure can be coated in an elastic polymer, rubber or other elastomeric material. In examples, rotors/impellers/propellers included in examples according to this disclosure can be coated in a polyurethane. For example, rotors/impellers/propellers of agitator 324 and other agitators in sand separation systems according to this disclosure can include a metallic core and an elastic polymer, rubber or other elastomeric layer covering at least a portion of a plurality of working surfaces of the rotor/impeller/propeller. In examples, the polymeric coating covering the impeller(s)/propeller(s) of the rotor assemblies of agitator 324 can have a durometer in a range from approximately 20 to approximately 70.

Additionally, to prevent initial clogging as raw slurry is introduced into raw slurry reservoir 302, the rotors/impellers/propellers of agitator 324 may be clocked circumferentially in the reservoir relative to slurry inlet 322 and outlet 326 of the reservoir and may be configured to generate flow of the slurry in a prescribed direction, e.g. clockwise or counterclockwise. In an example, a cylindrical raw slurry reservoir 302 includes agitator 324 including a plurality of rotor assemblies positioned in a range from approximately three to approximately twelve inches from the bottom of the reservoir. Raw slurry reservoir 302 can have a circular cross-sectional shape or other cross-sectional shapes, e.g., oblong, oval, as examples.

To improve proper mixing of the raw slurry in raw slurry reservoir 302 and properly distribute constituent materials of the slurry, the rotor assemblies of agitator 324 can be spaced from one another by a predetermined amount. In examples, the rotor assemblies of agitator 324 are spaced from one another by a distance in a range from approximately 4 to approximately 8 feet. Additionally, in examples, the rotor assemblies of agitator 324 can be spaced from inlet 322 by a distance in a range from approximately 2 to approximately 4 feet.

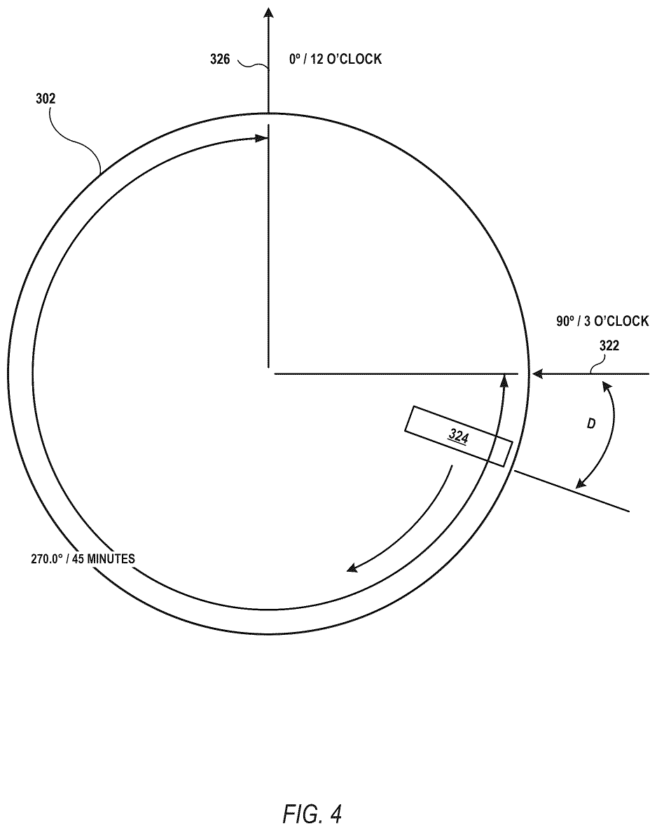

In an example, a portion of which is schematically depicted in FIG. 4, raw slurry is introduced into slurry reservoir 302 via inlet 322 at approximately 3 o'clock or 90 degrees from a 12 o'clock position and slurry outlet 326 out of which the mixed slurry in the reservoir is transferred for further processing in the system is at the 12 o'clock or 0-degree position. In this example, agitator 324 can be positioned circumferentially at greater than the 3 o'clock/90-degree position and configured to generate clockwise flow of the slurry. In examples, the agitator in a raw slurry tank is positioned circumferentially in the reservoir and configured to generate flow in either a clockwise or counterclockwise direction such that the agitator moves the slurry from a raw slurry inlet 270 degrees (45 minutes) or more before it reaches the raw slurry reservoir outlet. Additionally, in examples, agitator 324 may be positioned a predetermined minimum distance, D, downstream (in the direction of flow in slurry in reservoir 302) of inlet 322. In an example, agitator 124 may be positioned a distance, D, in a range from approximately 2 to approximately 4 feet downstream (in the direction of flow in slurry in reservoir 302) of inlet 322.

Referring again to FIG. 3, pump(s) 308 draw the mixed raw slurry from slurry reservoir 302 via outlet 326. In examples, pump(s) 308 can include one or more, e.g. two positive displacement pumps. The stroke of pump(s) can be set to evacuate all of the material, e.g. sand at the bottom of the stroke. In examples, sensors/switches are employed to control the stroke of pump(s) 308. For example, non-contact proximity switch(es) can be employed to control pump stroke. Pump(s) 308 draw the mixed raw slurry from slurry reservoir 302 and pump the slurry to first hydrocyclone stage 309. Although sand separation system 300 is depicted with pump(s) 308 located downstream of outlet 326 of slurry reservoir 302, the example system and other systems in accordance with this disclosure can include additional pumps at additional locations to convey fluid through the system.

In examples, sand separation system 300 (and other example systems in accordance with this disclosure) can include two hydrocyclone stages 309 and 313 in parallel with one or more hydrocyclones 310 and 314 in each stage. For example, each of first and second hydrocyclone stages 309 and 313 can include two hydrocyclones. In examples, each hydrocyclone can include an adjustable vortex finder and adjustable apex. Each of first stage hydrocyclone(s) 310 and second stage hydrocyclone(s) 314 is configured to separate constituent materials of the slurry flowing through the system.

Including two hydrocyclone stages in parallel in the system can improve the sand separation from the slurry. In examples, the dual parallel hydrocyclones 310 and 314 improves liquid and solid organic material separation from the sand in the slurry, which reduces the load on tub separator 316 downstream of the hydrocyclones and ultimately improves the quality and quantity of sand output by system 300. For example, employing two stages of hydrocyclone separation in parallel can improve bulk/large and fine/small material separation from the sand such that a substantial majority of, e.g., liquid and solid organic materials are separated from the sand before washing and further separation in tub separator 316.

Additionally, each of first stage hydrocyclone(s) 310 and second stage hydrocyclone(s) 314 can include an adjustable vortex finder and apex. The adjustable vortex finder and apex can improve the flexibility to modulate the hydrocyclone separation of materials for different system pressures, versus requiring a fixed system pressure for a prescribed and non-adjustable vortex finder and can allow hydrocyclone stages 309 and 313 to be tuned for improved sand separation across both stages.

First stage hydrocyclone(s) 310 includes tangential feed inlet 350, adjustable vortex finder (overflow conduit) 352, and adjustable apex (spigot/underflow conduit) 354. In examples, each of adjustable vortex finder 352 and adjustable apex 354 can include an adjustable aperture, which can be changed to modulate the material separation performance of first stage hydrocyclone(s) 310. Additionally, adjustable vortex finder 352 can include overflow conduit that can be adjustably arranged toward the top of first stage hydrocyclone(s) 310 such that vortex finder 352 can have a deeper or more shallow insertion into the hydrocyclone(s).

Second stage hydrocyclone(s) 313 includes tangential feed inlet 360, adjustable vortex finder (overflow conduit) 362, and adjustable apex (spigot/underflow conduit) 364. In examples, each of adjustable vortex finder 362 and adjustable apex 364 can include an adjustable aperture, which can be changed to modulate the material separation performance of second stage hydrocyclone(s) 313. Additionally, adjustable vortex finder 362 can include overflow conduit that can be adjustably arranged toward the top of second stage hydrocyclone(s) 313 such that vortex finder 362 can have a deeper or more shallow insertion into the hydrocyclone(s).

The slurry from raw slurry reservoir 302 enters first stage hydrocyclone(s) 310 tangentially via tangential feed inlet 350. And pre-processed fluid from pre-separation reservoir 312 enters second stage hydrocyclone(s) 313 tangentially via tangential feed inlet 360. In both first stage hydrocyclone(s) 310 and second stage hydrocyclone(s) 313, the tangentially fed slurry splits into two spirals: an outer, downward helical stream and an inner, upward vortex. Centrifugal force drives denser/larger particles outward, which spiral down to the apex (underflow) into tub separator 316. Less dense/smaller particles and liquids move inward, join the inner vortex/air core region, and exit via the vortex finder (overflow).

In examples, the size, e.g. diameter of adjustable vortex finder 352 and adjustable apex 354 of first stage hydrocyclone(s) 310 and adjustable vortex finder 362 and adjustable apex 364 of second stage hydrocyclone(s) 313 can be adjusted to improve sand separation from other materials in the slurry across hydrocyclone stages 309 and 313. For example, first stage hydrocyclone(s) 310 of first hydrocyclone stage 309 can be tuned to underflow most of the sand in the slurry while also underflowing a relatively large amount of other dense/large solid materials and some liquids. And, second stage hydrocyclone(s) 314 of second hydrocyclone stage 313 can be tuned to throttle underflow to finer/smaller particles and overflow most of the liquid and denser/larger materials.

In examples, adjustable apex 354 of first stage hydrocyclone(s) 310 is set to have a relatively larger apex aperture diameter. Setting adjustable apex 354 of first stage hydrocyclone(s) 310 to a relatively larger diameter will result in higher volume and courser underflow, resulting in most of the sand in the slurry and a relatively large amount of other dense/large solid materials and some liquid moving to tub separator 316 in first hydrocyclone stage 309. In examples, adjustable apex 354 of first stage hydrocyclone(s) 310 is set to a apex aperture diameter in a range from approximately 30 mm to approximately 50 mm. In an example, adjustable apex 354 of first stage hydrocyclone(s) 310 is set to a apex aperture diameter of approximately 50 mm. In examples, underflow out of first stage hydrocyclone(s) 310 of first hydrocyclone stage 309 into tub separator 316 can include up to approximately 6000 grams of sand per gallon of raw slurry (e.g., 95-99% of sand will be separated in first stage).

In addition to or in lieu of changing the apex aperture diameter of adjustable apex 354 of first stage hydrocyclone(s) 310, the vortex aperture diameter of adjustable vortex finder 352 and/or the insertion depth of overflow conduit of adjustable vortex finder 352 can also be modulated to improve sand separation by system 300.

The underflow from first stage hydrocyclone(s) 310 includes too much non-sand solid material and thus must be processed further by sand washing system 300. The underflow from first stage hydrocyclone(s) 310 is therefore bulk separated in tub separator 316 and the non-sand solids and some sand (adhered to/still in suspension with the non-sand solids) is weired off and out of tub separator 316 into pre-separation reservoir 312 for fine separation in second hydrocyclone stage 313.

Tub separator 316 can include inner weir 328 nested within and concentric with a liquid retaining outer tub 330 and agitator 332 aligned with a central axis of the basket and tub. Tub separator 316 can include a conical lower portion in which sand collects before exiting outlet 334 of the tub separator to be processed by one or more augers 318. The partially processed fluid, e.g. underflow from first stage hydrocyclone(s) 310 and second stage hydrocyclone(s) 314 is received in tub separator 316, e.g. in inner weir 328 and is processed by one or more mechanisms to further separate sand from liquid and other solids, e.g., organic solids, which separated fluid mixture is weired off and out of system as it collects toward the top of the tub and flows over inner weir 328 into outer tub 330.

Tub separator 316 includes agitator 332, which can be configured to spin about the central axis and can include a plurality of radially extending fingers 336 distributed along a length of a central agitator shaft 338. Agitator 332 can also include base fingers 340, which, further agitate the sand in the bottom of tub separator 316 and direct sand toward one or more apertures in the bottom of the tub separator to allow the sand to exit via outlet 334 for further (in some examples, final) processing by auger(s) 318.

Agitator 332 can spin to cause fingers 336 to move through the slurry in tub separator 316. Gravity and centrifugal forces in tub separator 316 with the rotating agitator 332 will cause the liquid and less dense/lighter solids to be expelled radially outward to be weired off from inner weir 328 into outer tub 330, while the sand is taken out of suspension in, e.g., the organic solids (or other solids in the mixture) and collects in the bottom of the separator tub.

Tub separator 316 may also employ a sand washing system to further separate the sand from, e.g., solid organics in the tub separator. The flush liquid used in the sand washing system can be supplied from different sources and introduced in tub separator 316 at different locations. The flush liquid can come from, e.g. flush reservoir 306 via flush supply line 342, as depicted in the example of FIG. 3. Additionally, the flush liquid employed to wash sand in tub separator 316 can be fresh water (potable or non-potable) pumped into sand separation system 300 from a local or remote water source.

In examples, a flush liquid, e.g. water is introduced toward the middle to upper portions of tub separator 316 and thereby caused to flow through the sand collected therein. For example, flush water is introduced from the side/periphery of tub separator 316 via supply line 342 toward the middle to upper portions of the tub. Additionally, as depicted in the example of FIG. 3, the flush water is introduced via another branch of supply line 342 from below sand collected in the bottom of tub separator 316. Flush water introduced below sand collected in the bottom of tub separator 316 can function to backwash the accumulated sand in the bottom of tub separator 316 by separating out lighter/less dense solids and pushing them upward.

In examples including the example of FIG. 3, one or more flush liquid conduits 344 are arranged across an interior dimension, e.g., across the diameter of tub separator 316 to better distribute the flush liquid in the tub. The flush liquid cleans and separates the sand in tub separator 316 by separating out lighter/less dense solids and pushing them upward. The action of agitator 332 of tub separator 316 and the sand washing using flush liquid pumped into the tub separator via flush water conduits 344 and backwashing via the lower branch of supply line 342 can improve separation and cleansing of the sand in the system.

In addition to directing a flush liquid into tub separator 316, air can be employed to assist in separating unwanted materials form the sand and to reduce water (or other liquid) consumption. In examples, air can be introduced into tub separator 316 at one or more locations, which can act to break organic solids from sand and air bubbles in the fluid mixture may also act to carry organic solids upward in the fluid in the tub to be weired off and out of the system.

As noted above, the underflow from first stage hydrocyclone(s) 310 is bulk separated in tub separator 316 and the non-sand solids and some sand (adhered to/still in suspension with the non-sand solids) is weired off and out of tub separator 316 into pre-separation reservoir 312. The pre-processed fluid from pre-separation reservoir 312 enters second stage hydrocyclone(s) 313 tangentially via tangential feed inlet 360. Second stage hydrocyclone(s) 314 of second hydrocyclone stage 313 can be tuned to throttle underflow to finer/smaller particles and overflow most of the liquid and denser/larger materials in the pre-processed fluid received from pre-separation reservoir 312.

In examples, adjustable apex 364 of second stage hydrocyclone(s) 314 is set to have a relatively smaller apex aperture diameter than, e.g., the apex aperture of adjustable apex 354 of first stage hydrocyclone(s) 310. Setting adjustable apex 364 of second stage hydrocyclone(s) 314 to a relatively smaller diameter will result in lower volume and finder underflow, resulting in a relatively large amount of non-sand dense/large solid materials and most liquid overflowing and relatively small/fine particles and a small amount of liquid underflowing into tub separator 316 in second hydrocyclone stage 313. In examples, adjustable apex 364 of second stage hydrocyclone(s) 314 is set to an apex aperture diameter in a range from approximately 15 mm to approximately 30 mm. In an example, adjustable apex 364 of second stage hydrocyclone(s) 314 is set to an apex aperture diameter of approximately 22 mm. In examples, underflow out of second stage hydrocyclone(s) 314 of second hydrocyclone stage 313 into tub separator 316 can include up to 600 grams of sand per gallon of pre-separation fluid from pre-separation reservoir 312.

In addition to or in lieu of changing the apex aperture diameter of adjustable apex 364 of second stage hydrocyclone(s) 314, the vortex aperture diameter of adjustable vortex finder 362 and/or the insertion depth of overflow conduit of adjustable vortex finder 362 can also be modulated to improve sand separation by system 300.

The underflow out of second stage hydrocyclone(s) 314 of second hydrocyclone stage 313 into tub separator 316 is therefore mostly liquid with relatively small amounts of sand and small/fine particles. While the separation and washing mechanisms of tub separator 316 described above, e.g. inner weir 328 nested within and concentric with liquid retaining outer tub 330, agitator 332, and flush liquid conduits 344 can be well adapted to separating sand from liquids and larger/bulkier solids, separation of sand from smaller/finer particles, e.g. fine ground up canola particles may be difficult using these mechanisms.

In examples, sand separation system 300 includes sand washing jet(s) 370, which can include wash liquid conduit(s) 372 and 378 delivering liquid from source 374 to nozzle(s) 376 and 380. As with flush liquid delivered via flush liquid conduits 344 to separate and wash sand in tub separator 316, source 374 of liquid used by sand washing jet(s) 370 can include, e.g., flush liquid from flush reservoir 306 via flush supply line 342 and/or fresh water (potable or non-potable) pumped into sand separation system 300 from a local or remote water source. Sand washing jet(s) 370 can be configured and arranged to separate smaller/finer particles, e.g. fine ground up canola particles from sand in the underflow from out of second stage hydrocyclone(s) 314 of second hydrocyclone stage 313. Additionally, sand washing jet(s) 380 can be arranged between tub separator 316 and auger(s) 318, e.g. along outlet 334 for additional washing and separation of the sand before auger(s) 318 and also to dislodge and keep flowing sand from the tub to the auger(s).

In examples, nozzle(s) 376 can be arranged adjacent the stream of underflow fluid from second stage hydrocyclone(s) 314 of second hydrocyclone stage 313. As the underflow fluid exits second stage hydrocyclone(s) 314 of second hydrocyclone stage 313 and enters tub separator 316, nozzle(s) 376 spray liquid at the underflow and effectively knock smaller/finer particles, e.g. fine ground up canola particles off of the sand grains.

After processing by first hydrocyclone stage 309, second hydrocyclone stage 313, and tub separator 316, separated and washed sand collects in the bottom of tub separator 316. Base fingers 340 further agitate the sand in the bottom of tub separator 316 and direct sand toward one or more apertures in the bottom of the tub separator to allow the sand to exit via outlet 334 for further (in some examples, final) processing by auger(s) 318.

In examples, a plurality of augers 318, e.g. two or more augers 318, e.g. three augers 318 are employed in sand separation system 300. In examples, auger(s) 318 can be shaftless auger(s), which can function to assist with sand separation by allowing liquid to leave the sand as it travels upward in an enclosed tube in which each auger is arranged. The auger tubes can be made from a variety of materials. In an example, the auger tubes are made from a stainless steel and with an HDPE lining, or another material with similar characteristics as HDPE. In examples, auger(s) 318 can operate continuously.

Additionally, in examples, auger(s) 318 can run periodically. For example, one or more of auger(s) 318 can be controlled to run for a period of time and can be shut down for a period of time. Different ones of auger(s) 318 can be run on different schedules/frequencies of operation and multiple of auger(s) 318 can be run on the same schedule/at the same frequency.

In multiple stages of separation and washing of fluids flowing through sand separation system 300, byproducts of processing, e.g., organic or non-sand inorganic liquids and/or solids are moved to various components of the system, e.g. discharge reservoir 304, flush reservoir 306, sloped separator 320, and even back to raw slurry reservoir 302. For example, overflow from first stage hydrocyclone(s) 310 and second stage hydrocyclone(s) 314 of first and second hydrocyclone stages 309 and 313 flows to sloped separator 320, which functions to separate liquids and solids. The liquids (and some fine particles which can include sand and sand in suspension with other fine solids) separated in sloped separator 320 can be sent to flush reservoir 306, while the solids (and some liquids) are sent to discharge reservoir 304.

Additionally, liquids and solids from discharge reservoir 304 and/or flush reservoir 306 can be moved back to raw slurry reservoir 302 to be added to the unprocessed slurry and sent back through sand separation system 300. This return slurry of materials can serve additional functions in sand separation system 300 other than returning the slurry to the system for repeated processing, e.g. repeated sand separation. In examples, liquids from flush reservoir 306 can be employed to dilute the slurry mixture in raw slurry reservoir 302. Optimal operation of hydrocyclones can depend on several factors, including characteristics of the slurry mixture processed by the devices, e.g., a consistent slurry liquid to solid ratio of the slurry. Characteristics of the slurry entering the system via raw slurry reservoir 302, including the liquid-to-solid ratio can be monitored and diluting liquids from flush reservoir 306 can be selectively directed to reservoir 302 to modulate this or other characteristics of the slurry.

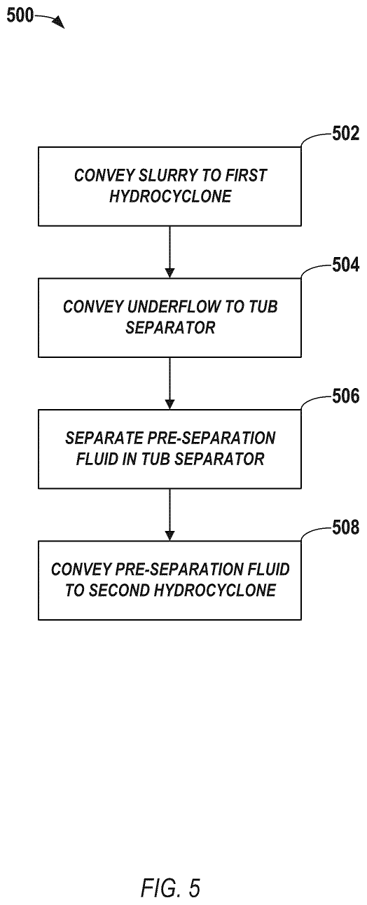

FIG. 5 is a flowchart depicting an example method 500 of separating sand from other solids and liquids in a slurry. Method 500 according to examples of this disclosure includes conveying the slurry to a first hydrocyclone having a first adjustable vortex finder and first adjustable apex (502), conveying underflow of the first hydrocyclone from the first apex to a tub separator (504), separating a pre-separation fluid including sand and other solids and liquids in the tub separator (506), and conveying the pre-separation fluid to a second hydrocyclone having a second adjustable vortex finder and second adjustable apex via which underflow of the second hydrocyclone is conveyed to the tub separator in parallel with the underflow of the first hydrocyclone (508).

A non-limiting numbered list of certain Aspects of the present disclosure are included below.

Aspect 1 can include system, device, or method that can include or use a first hydrocyclone comprising a first adjustable apex via which underflow of the first hydrocyclone is conveyed; and a second hydrocyclone comprising a second adjustable apex via which underflow of the second hydrocyclone is conveyed, wherein a first apex aperture diameter of the first adjustable apex is greater than a second apex aperture diameter of the second adjustable apex.

Aspect 2 can include or use the system, device, or method of Aspect 1, wherein the first apex aperture diameter of the first adjustable apex is in a range from approximately 30 millimeters (1.181 inches) to approximately 50 millimeters (1.969 inches).

Aspect 3 can include or use the system, device, or method of Aspect 2, wherein the first apex aperture diameter of the first adjustable apex is approximately equal to 50 millimeters (1.969 inches).

Aspect 4 can include or use the system, device, or method of Aspect 1, wherein the second apex aperture diameter of the second adjustable apex is in a range from approximately 15 millimeters (0.59 inches) to approximately 30 millimeters (1.181).

Aspect 5 can include or use the system, device, or method of Aspect 4, wherein the second apex aperture diameter of the second adjustable apex is approximately equal to 22 millimeters (0.866 inches).

Aspect 6 can include or use the system, device, or method of Aspect 1, further comprising a tub separator, wherein: the first hydrocyclone comprises a first tangential inlet fluidically connected to a flow of slurry comprising organics and inorganic sand; and underflow of the first hydrocyclone is conveyed via the first adjustable apex to the tub separator.

Aspect 7 can include or use the system, device, or method of Aspect 6, further comprising a tub separator, wherein: the second hydrocyclone comprises a second tangential inlet fluidically connected to a flow of fluid from the pre-separation reservoir; and the underflow of the second hydrocyclone is conveyed via the second adjustable apex to the tub separator.

Aspect 8 can include or use the system, device, or method of Aspect 6, further comprising a raw slurry reservoir fluidically connected to the first tangential inlet of the first hydrocyclone.

Aspect 9 can include or use the system, device, or method of Aspect 1, further comprising a raw slurry reservoir to which the first hydrocyclone is fluidically connected to receive a flow of slurry comprising organics and inorganic sand.

Aspect 10 can include or use the system, device, or method of Aspect 9, further comprising an agitator comprising a plurality of rotor assemblies in the reservoir and configured to be submerged in the slurry, wherein: each rotor assembly comprises a motor operatively connected and configured to rotate an propeller; and a power of the motor, a rate of rotation of the propeller, and a size of the propeller of each of the plurality of rotor assemblies is selected to both propel and mix the slurry in the reservoir without taking the sand out of suspension with other solids in the slurry.

Aspect 11 can include or use the system, device, or method of Aspect 10, wherein each of the motors of each of the plurality of rotor assemblies comprises a power in a range from approximately 4 to approximately 30 HP.

Aspect 12 can include or use the system, device, or method of Aspect 11, wherein each of the motors of each of the plurality of rotor assemblies comprises a power of approximately 12.2 HP.

Aspect 13 can include or use the system, device, or method of Aspect 10, wherein each of the propellers of each of the plurality of rotor assemblies comprises an outer diameter in a range from approximately 24 to approximately 43 inches.

Aspect 14 can include or use the system, device, or method of Aspect 13, wherein each of the propellers of each of the plurality of rotor assemblies comprises an outer diameter of approximately 38 inches.

Aspect 15 can include or use the system, device, or method of Aspect 10, wherein each of the propellers of each of the plurality of rotor assemblies comprises a rate of rotation in a range from approximately 120 to approximately 200 RPMs.

Aspect 16 can include or use the system, device, or method of Aspect 15, wherein each of the propellers of each of the plurality of rotor assemblies comprises a rate of rotation in a range from approximately 150 to approximately 175 RPMs.

Aspect 17 can include or use the system, device, or method of Aspect 16, wherein each of the propellers of each of the plurality of rotor assemblies comprises a rate of rotation of approximately 160 RPMs.

Aspect 18 can include system, device, or method that can include or use a first hydrocyclone having a first adjustable vortex finder and first adjustable apex via which underflow of the first hydrocyclone is conveyed to the tub separator; and a second hydrocyclone having a second adjustable vortex finder and second adjustable apex via which underflow of the second hydrocyclone is conveyed to the tub separator in parallel with the underflow of the first hydrocyclone, wherein a first apex aperture diameter of the first adjustable apex is greater than a second apex aperture diameter of the second adjustable apex.

Aspect 19 can include system, device, or method that can include or use conveying the slurry to a first hydrocyclone having a first adjustable vortex finder and first adjustable apex; conveying underflow of the first hydrocyclone from the first apex to a tub separator; separating a pre-separation fluid including sand and other solids and liquids in the tub separator; and conveying the pre-separation fluid to a second hydrocyclone having a second adjustable vortex finder and second adjustable apex via which underflow of the second hydrocyclone is conveyed to the tub separator in parallel with the underflow of the first hydrocyclone.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, the code can be tangibly stored on one or more volatile or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

Examples, as described herein, may include, or may operate on, logic or a number of components, modules, or mechanisms. Modules may be hardware, software, or firmware communicatively coupled to one or more processors in order to carry out the operations described herein. Modules may hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

The above description is intended to be illustrative, and not restrictive. For example, the above-described examples (or one or more aspects thereof) may be used in combination with each other. Other embodiments can be used, such as by one of ordinary skill in the art upon reviewing the above description. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

Various aspects of the disclosure have been described. These and other aspects are within the scope of the following claims.

What is claimed is:

1. A sand separation system comprising:
a first hydrocyclone comprising a first adjustable apex via which underflow of the first hydrocyclone is conveyed; and
a second hydrocyclone comprising a second adjustable apex via which underflow of the second hydrocyclone is conveyed,
wherein a first apex aperture diameter of the first adjustable apex is greater than a second apex aperture diameter of the second adjustable apex.

2. The system of claim 1, wherein the first apex aperture diameter of the first adjustable apex is in a range from approximately 30 millimeters (1.181 inches) to approximately 50 millimeters (1.969 inches).

3. The system of claim 2, wherein the first apex aperture diameter of the first adjustable apex is approximately equal to 50 millimeters (1.969 inches).

4. The system of claim 1, wherein the second apex aperture diameter of the second adjustable apex is in a range from approximately 15 millimeters (0.59 inches) to approximately 30 millimeters (1.181).

5. The system of claim 4, wherein the second apex aperture diameter of the second adjustable apex is approximately equal to 22 millimeters (0.866 inches).

6. The system of claim 1, further comprising a tub separator, wherein:
the first hydrocyclone comprises a first tangential inlet fluidically connected to a flow of slurry comprising organics and inorganic sand; and
underflow of the first hydrocyclone is conveyed via the first adjustable apex to the tub separator.

7. The system of claim 6, further comprising a pre-separation reservoir, wherein:
the second hydrocyclone comprises a second tangential inlet fluidically connected to a flow of fluid from the pre-separation reservoir; and
the underflow of the second hydrocyclone is conveyed via the second adjustable apex to the tub separator.

8. The system of claim 6, further comprising a raw slurry reservoir fluidically connected to the first tangential inlet of the first hydrocyclone.

9. The system of claim 1, further comprising a raw slurry reservoir to which the first hydrocyclone is fluidically connected to receive a flow of slurry comprising organics and inorganic sand.

10. The system of claim 9, further comprising an agitator comprising a plurality of rotor assemblies in the raw slurry reservoir and configured to be submerged in the slurry, wherein:
each rotor assembly comprises a motor operatively connected and configured to rotate a propeller; and
a power of the motor, a rate of rotation of the propeller, and a size of the propeller of each of the plurality of rotor assemblies is selected to both propel and mix the slurry in the raw slurry reservoir without taking sand out of suspension with other solids in the slurry.

11. The system of claim 10, wherein each of the motors of each of the plurality of rotor assemblies comprises a power in a range from approximately 4 to approximately 30 HP.

12. The system of claim 11, wherein each of the motors of each of the plurality of rotor assemblies comprises a power of approximately 12.2 HP.

13. The system of claim 10, wherein each of the propellers of each of the plurality of rotor assemblies comprises an outer diameter in a range from approximately 24 to approximately 43 inches.

14. The system of claim 13, wherein each of the propellers of each of the plurality of rotor assemblies comprises an outer diameter of approximately 38 inches.

15. The system of claim 10, wherein each of the propellers of each of the plurality of rotor assemblies comprises a rate of rotation in a range from approximately 120 to approximately 200 RPMs.

16. The system of claim 15, wherein each of the propellers of each of the plurality of rotor assemblies comprises a rate of rotation in a range from approximately 150 to approximately 175 RPMs.

17. The system of claim 16, wherein each of the propellers of each of the plurality of rotor assemblies comprises a rate of rotation of approximately 160 RPMs.

18. A sand separation system comprising:
a tub separator;
a first hydrocyclone having a first adjustable vortex finder and first adjustable apex via which underflow of the first hydrocyclone is conveyed to the tub separator; and
a second hydrocyclone having a second adjustable vortex finder and second adjustable apex via which underflow of the second hydrocyclone is conveyed to the tub separator in parallel with the underflow of the first hydrocyclone,
wherein a first apex aperture diameter of the first adjustable apex is greater than a second apex aperture diameter of the second adjustable apex.

19. A method of separating sand from other solids and liquids in a slurry, the method comprising:
conveying the slurry to a first hydrocyclone having a first adjustable vortex finder and first adjustable apex;
conveying underflow of the first hydrocyclone from the first adjustable apex to a tub separator;
separating a pre-separation fluid including sand and other solids and liquids in the tub separator; and
conveying the pre-separation fluid to a second hydrocyclone having a second adjustable vortex finder and second adjustable apex via which underflow of the second hydrocyclone is conveyed to the tub separator in parallel with the underflow of the first hydrocyclone.
